(19) United States
(12) Patent Application Publication
(10) Pub. No.: US 2013/0212694 A1
(43) Pub. Date: Aug. 15, 2013

(54) METHOD AND APPARATUS FOR RF TRANSMITABLE DATA PROTECTION

(71) Applicants: Noel Francis Castiglia, Annapolis, MD (US); Walter Anthony Bagdon, III, Annapolis, MD (US)

(72) Inventors: Noel Francis Castiglia, Annapolis, MD (US); Walter Anthony Bagdon, III, Annapolis, MD (US)

(21) Appl. No.: 13/746,167

(22) Filed: Jan. 21, 2013

Related U.S. Application Data
(60) Provisional application No. 61/598,572, filed on Feb. 14, 2012.

(51) Int. Cl. G06F 21/60

(52) U.S. Cl. CPC G06F 21/60
USPC 726/26

(57) ABSTRACT

A method for prevention of unauthorized acquisition and use of privileged information including steps of: generating a spoof signature and associating the signature with the privileged information such that the spoof signature can be acquired during the unauthorized acquisition of the privileged information; establishing an identifying processor arranged to identify the at least one spoof signature, to classify attempts of unauthorized use of the privileged information, and generates at least one authorization for at least one predetermined set of actions organized to prevent the unauthorized use of the privileged information; and communicating authorizations to a party proximal to the at least one unauthorized use of the privileged information in time sufficient for interruption of the unauthorized use of the privileged information.

### RELATED APPLICATIONS

The current Application claims priority benefit of U.S. Provisional Application Ser. No. 61/598,572, filed Feb. 14, 2012, which is incorporated by reference herein in its entirety.

### FIELD OF THE INVENTION

The current invention relates to methods and devices for protecting privacy and countering fraud via proprietary data protection, by prevention of unauthorized extraction and unauthorized use of information. More particularly, the current invention pertains to non contact Radio frequency Identification (RFID) countermeasures & spoofing devices using different passive and active layers.

### BACKGROUND OF THE INVENTION

Cyber crime, cyber warfare and electronic warfare exhibit evolution from predominately military problems toward commercial and civilian problems. Cost effective solutions may be needed to protect military, industry and civilians from serious privacy and identity vulnerabilities in an increasingly complex communications and electronic surveillance environment. In environments where hackers can promulgate viruses and worms causing potentially serious damage to infrastructure, power generation and/or public transportation a multi-layered protection strategy may be of interest. Fraud may represent but one aspect of the security problems, but the fraudulent acquisition and misuse of privileged information warranting protection which may include, but not be limited to, personal, financial, and/or identity-related information may be among priority interest at least because of the ubiquity and frequency of use.

In addition, logistics networks, [commercial, military and government sectors], are significantly increasing the use of RFID inventory networks for warehouse, container staging areas, maritime shipping, commercial tools, department stores and tracking aerospace parts or even munitions or dangerous hazardous waste; all now vulnerable to electronic eavesdropping and hostile tracking & surveillance. Also, proprietary, personalized, and/or privileged information and data may be contained and supported by variety of commonly used objects and media including, but not limited to: identification cards and passes, personal identification documents and chips, credit and debit cards, department store cards, restricted access cards and chips, electronic keys, electronic passes and tickets, boarding cards and passes, luggage and parcel identification labels and chips, public transportation tickets and passes, parking tickets and passes, laundry labels and smart cards, electronically-enabled receipts, electronic toll passes, electronically-encoded objects and documents, and combination of the listed media,

Having in mind diverse and expending practice of incorporating a variety of electronically identifiable non-contact RFID technologies, chips, and pins in modern contactless credit cards, ID cards and passport, these contactless cards and passports may become vulnerable to fraud. For example, a simple mobile RFID reader and a laptop computer may interrogate a RFID card and obtain the users credit card information or encoded RFID data if not adequately protected.

Contactless technologies, including starboards, proximity cards, and RFID-based devices are constantly increasing in ubiquity in such applications as access control and payment systems. These contactless technologies are vulnerable to a class of relay attacks using NFC enabled mobile phones called “ghost-and-leech” or “relay-and-proxy” attacks. This is difficult to defend using encryption techniques because the relay does not change the encrypted card information or corrupt the EPC or UPC data,

This may be subsequently used to purchase items or steal personalized, protected, or identity-related information. A variety of spoofing devices in accordance with the current invention may provide a choice of countermeasures using, for example, an RFID chip, antenna and parasitic element, or multiple independent or array elements to enhance a spoofing signal in order to spoof the intruder signal who is trying to read the card unobtrusively. One feature of the RF spoofing device of the current invention may include a card number where the encoded preassigned numbers or encryption codes may be readily accessible by the protective entities including, but not limited to, United States government, credit card company fraud division, credit ratings agencies, major credit bureaus, banks, law enforcement, homeland security, medical privacy groups, and/or the fraud divisions of stores or credit card companies at the point of sale, on line, or in middleware,

Virtually all authorizing issuing agencies or organizations responsible for programming RFID devices may provide a preassigned spoof code that indicates when a fraudulent transaction may be occurring at the point of sale; allowing the user or the violator to be detained by security personnel, a security photo to be taken, alert store or mail security supporting service institutions, and/or the service provider who may need to testify that the incident took place. A passive deceptive spoofing device with pre assigned coded information may also be useful for tracking “on-line” fraudulent transaction attempts, and attempts at identity information misappropriation.

Possible applications of different embodiments of the current invention may be in domains of supply chain management, automated payment, physical access control, counterfeit prevention, airline baggage management, smart homes and/or offices. The RFID tags may also be implanted in different kinds of personal and consumer goods, partially assembled cars, sidewalks, wails, frozen meals, ski-lift passes, laundry smart-cards, clothing, E-ZPass® toll collection devices, and/or public transportation tickets, even in individuals or animals for a variety of anti eavesdropping applications, Law enforcement firearms, expensive tools, merchandise, high value aerospace parts are a partial listing.

Implantable RFID tags for human and animals [pets & livestock] that include security and health information may represent significant growth potential. Integration of spoof chip information as protection in existing animal libraries provides anonymity for valuable animals or in the future protection for human beings or prescription drugs with. RFID implanted information. As a current example, some implantable identification RFID device from PositiveID Corporation of Delray Beach, Fla. (formerly known as VeriChip™) may be reduced to approximately the size of a grain of rice. Protective devices and methods in accordance with the current invention may be implemented, to protect implantable RFID devices, inter alia, in a passive configuration as adhesive multilayered covers implemented on the body surfaces, incorporated in protective garments or wearable items, or incorporated into external obscuring shielding assemblies. In an active form embodiments, protective spoofing devices may include multichannel emitters arranged appropriately to radiate protective signals into a protected volume, for example using distributed and/or mutually correlated antenna configurations including but not limited to loop antennas, rod antennas, disc-cone antennas, end fire arrays, E-Plane notches, meander line antennas, spiral antennas, printed log periodic antennas, dish antennas, slot arrays, surface-mounted antennas and arrays, dipole and multipole antennas, antennas including reflectors, directors, horns, waveguides, strip lines, laser antennas, fluid components (incorporating conductive, semi-conductive or dielectric solids, liquids, gasses or plasmas).

It may be noted that particular antenna configurations or combination may vary in accordance with particular embodiment but should still be understood by practitioners as a variation of devices and methods under the scope of the current invention.

### SUMMARY OF THE INVENTION

A method for prevention of unauthorised acquisition and use of privileged information including steps of: generating a spoof signature and associating the signature with the privileged information such that the spoof signature can be acquired during the unauthorized acquisition of the privileged information; establishing an identifying processor arranged to identify the at least one spoof signature, to classify attempts of unauthorized use of the privileged information, and generates at least one authorization for at least one predetermined set of actions organized to prevent the unauthorized use of the privileged information; and communicating authorizations to a party proximal to the at least one unauthorised use of the privileged information in time sufficient for interruption of the unauthorized use of the privileged information.

### BRIEF DESCRIPTION OF THE DRAWINGS

FIG. 1 illustrates prior art methods and devices.

FIGS. 2A-E illustrate methods and devices in accordance with the current invention.

FIGS. 3A-B illustrate devices in accordance with the current invention.

FIG. 4 illustrates embodiments in accordance with the current invention.

FIG. 5 illustrates different embodiments in accordance with the current invention.

FIG. 6 illustrates additional different embodiments in accordance with the current invention.

FIG. 7 illustrates additional different embodiments in accordance with the current invention.

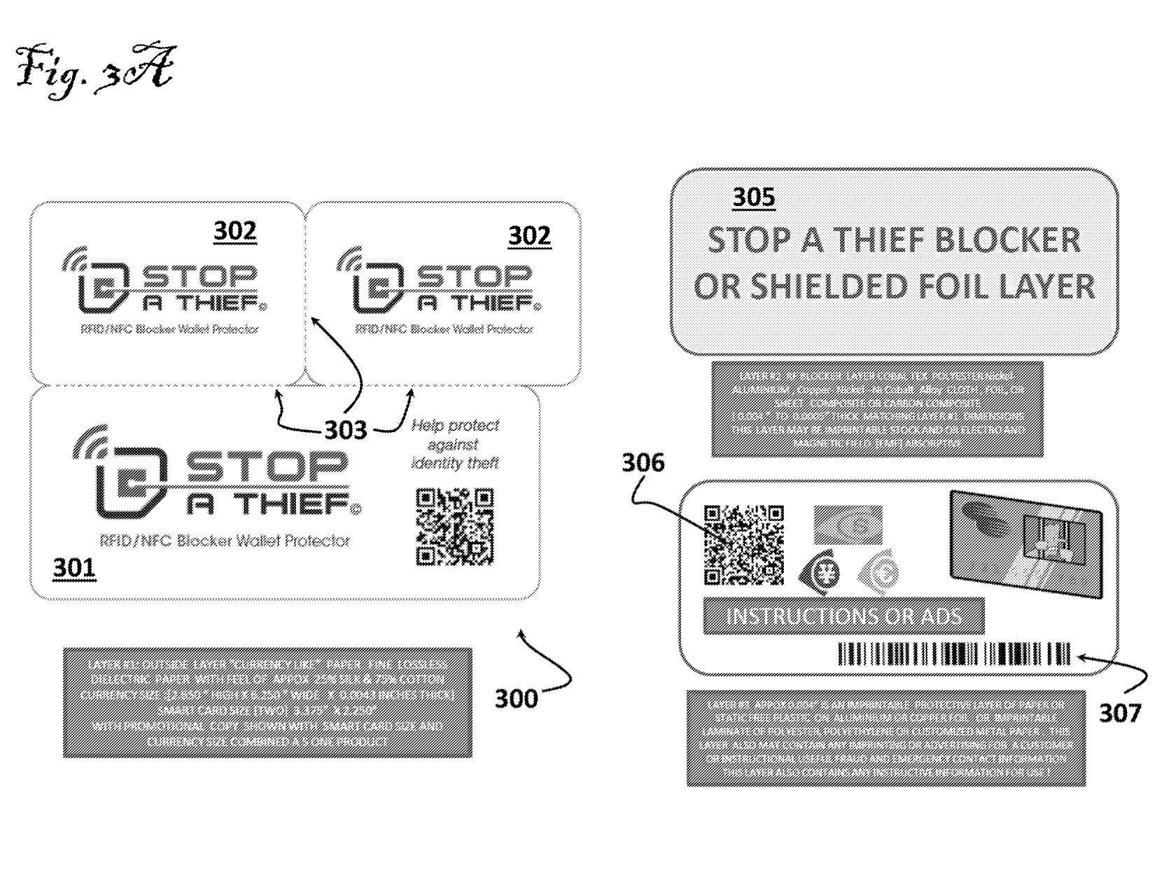

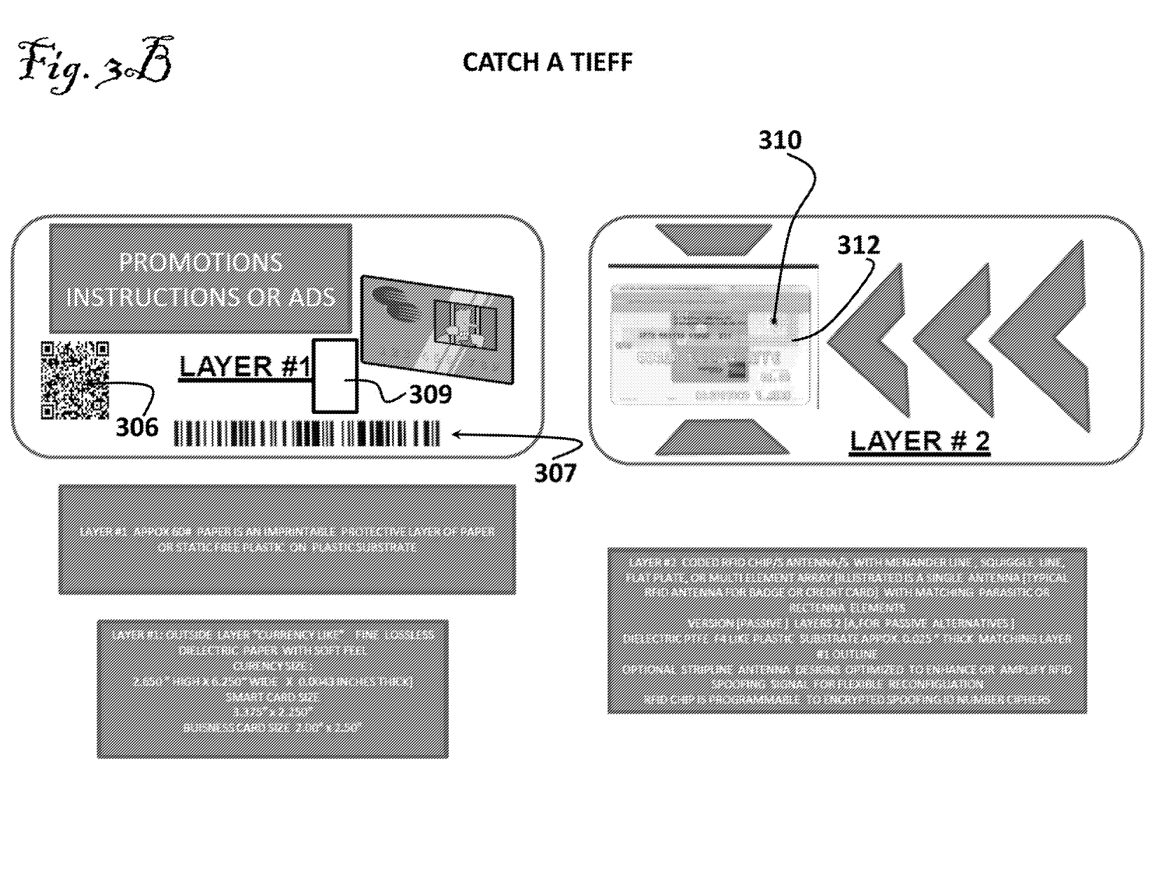

FIG. 3 illustrates additional different embodiments in accordance with the current invention.

FIG. 9 illustrates additional different embodiments in accordance with the current invention.

FIG. 10 illustrates additional different embodiments in accordance with the current invention.

FIG. 11 illustrates additional different embodiments in accordance with the current invention.

FIG. 12 illustrates additional different embodiments in accordance with the current invention.

FIG. 13 illustrates additional methods and devices in accordance with the current invention.

### DESCRIPTION OF SEVERAL EMBODIMENTS OF THE INVENTION

The current Invention may be better understood by referring to the following description, which should be read in conjunction with the accompanying drawings of particular exemplary embodiments. This description of the illustrated embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art may also understand that such equivalent assemblies do not depart from the spirit and scope of the invention in its broadest form.

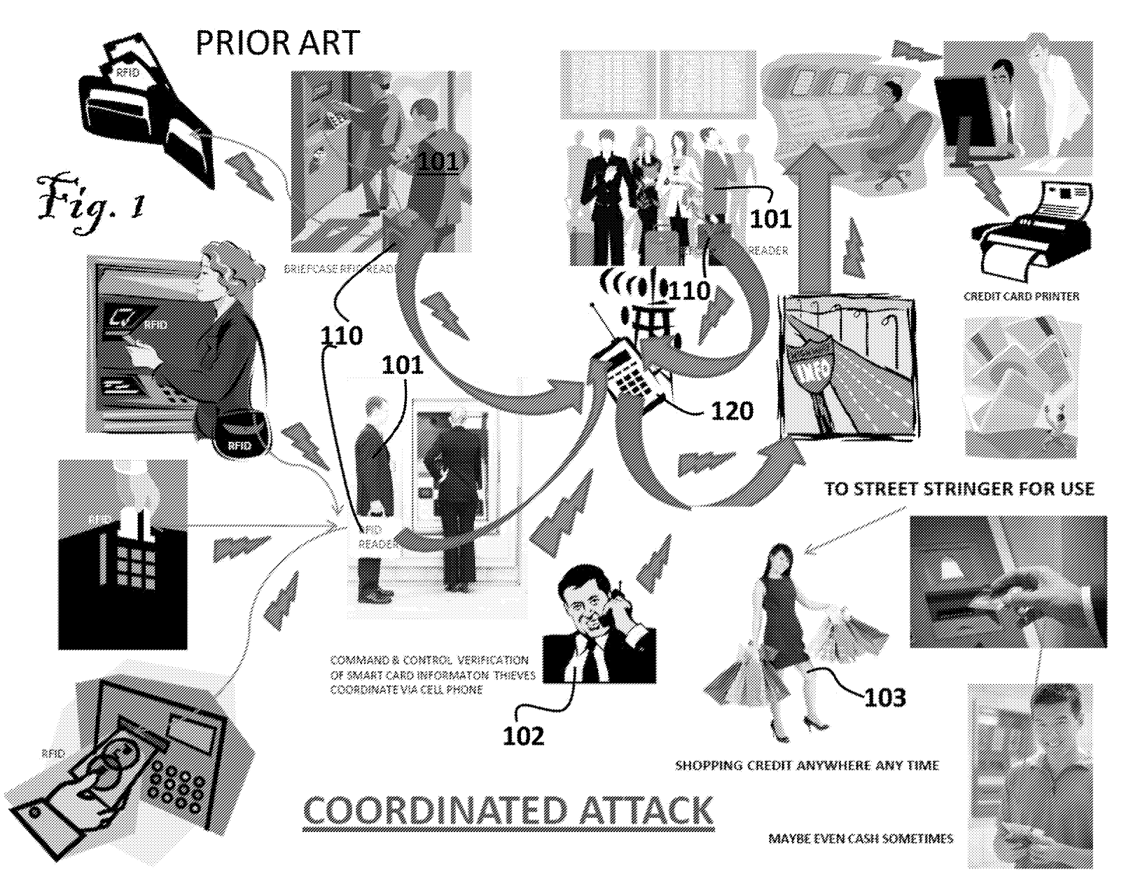

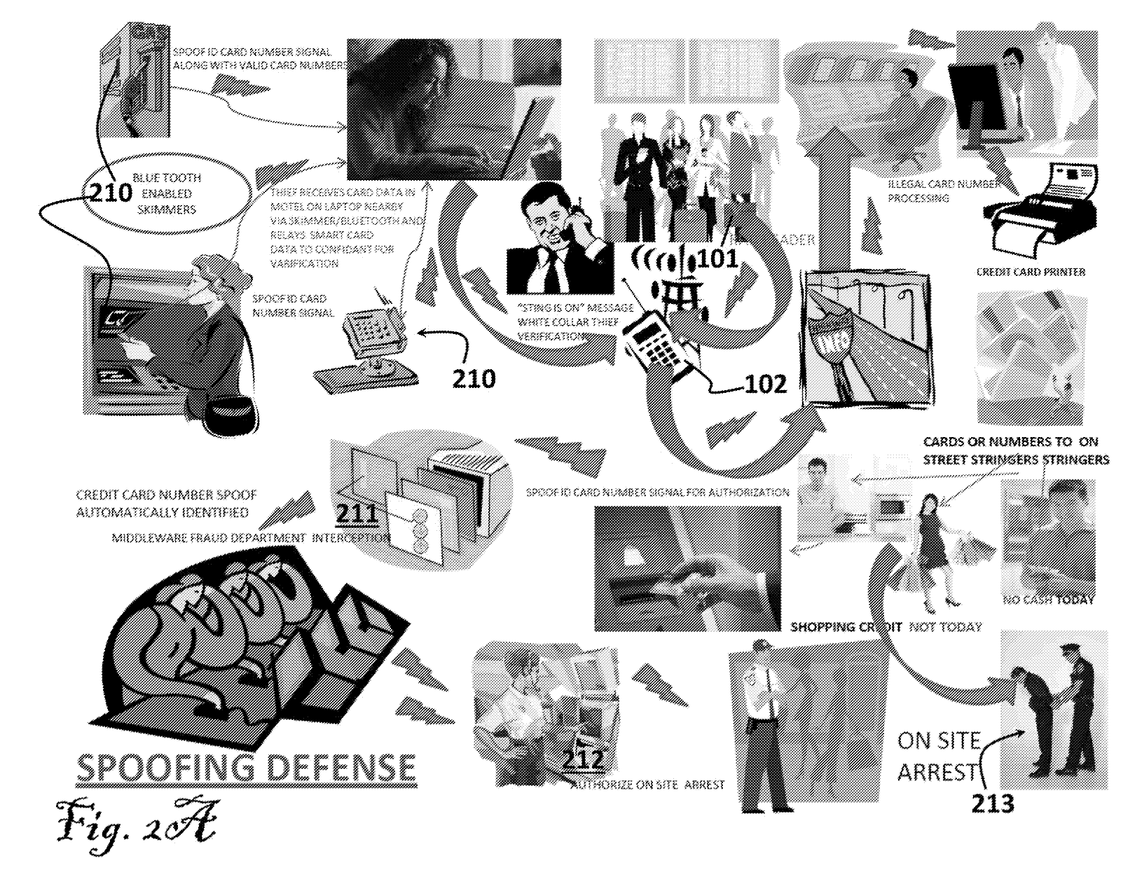

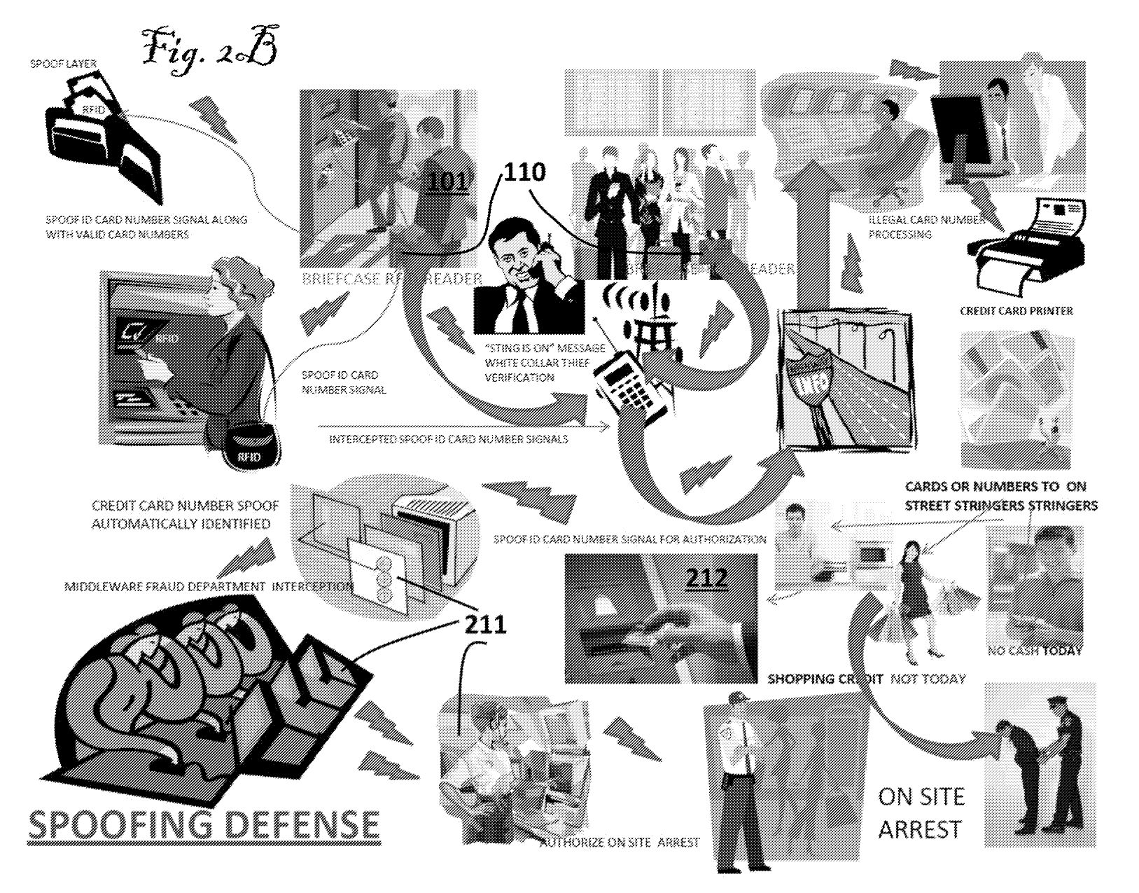

An exemplary schematic representation of a prior art (one of many possible) unauthorized extractions and criminal misuse of information stored on unprotected RFIDs is illustrated in FIG. 1. One should note that in the schematically illustrated process of FIG. 1, the illustrated deleterious, pernicious, and/or criminal activities may be performed by skimmers 101, handlers 102, a kingpin and stringers 103 in a plethora of forms, variations, and/or modifications, as routinely reported by many law enforcement, public and private organizations concerned by safety of electronic commerce. It may be noteworthy to emphasize that stored information may be misappropriated either during usage or while transported or stored being insufficiently protected lacking protective devices and methods of the current invention.

In FIG. 1, illustrate an exemplary “SKIM” operation using corrupted RFID readers including parasitic readers (e.g. “piggyback” readers arranged to intercept information intended for proximal legitimate readers), portable briefcase or laptop case disguised mobile reader 110 (e.g. an RFID reader and/or a Point of Sale [POS] reader commonly known and used by many users), or corrupted interceptor readers arranged to intercept information transmitted via data networks (e.g. area networks including well-known LAN, WLAN, MAN, SAN, CAN, PAN, DAN, and/or combinations).

Alternatively, uses of “Relay-and-Proxy” or “Leech-and-Ghost” attack schemes are also known. For example, using an NFC enabled, mobile smart phone using one “Leech” or “Relay” phone for skimming and a “Ghost” or “Proxy” phone for purchase in another location (e.g. different city) are also known. Similar basic scam may used to contact by a mobile phone 120, a thief 209 operating a computer terminal to place a product order on line or via telephone, When the products are delivered to a drop location thieves or stringer 103 may be used to deliver the product to a fence for cash.

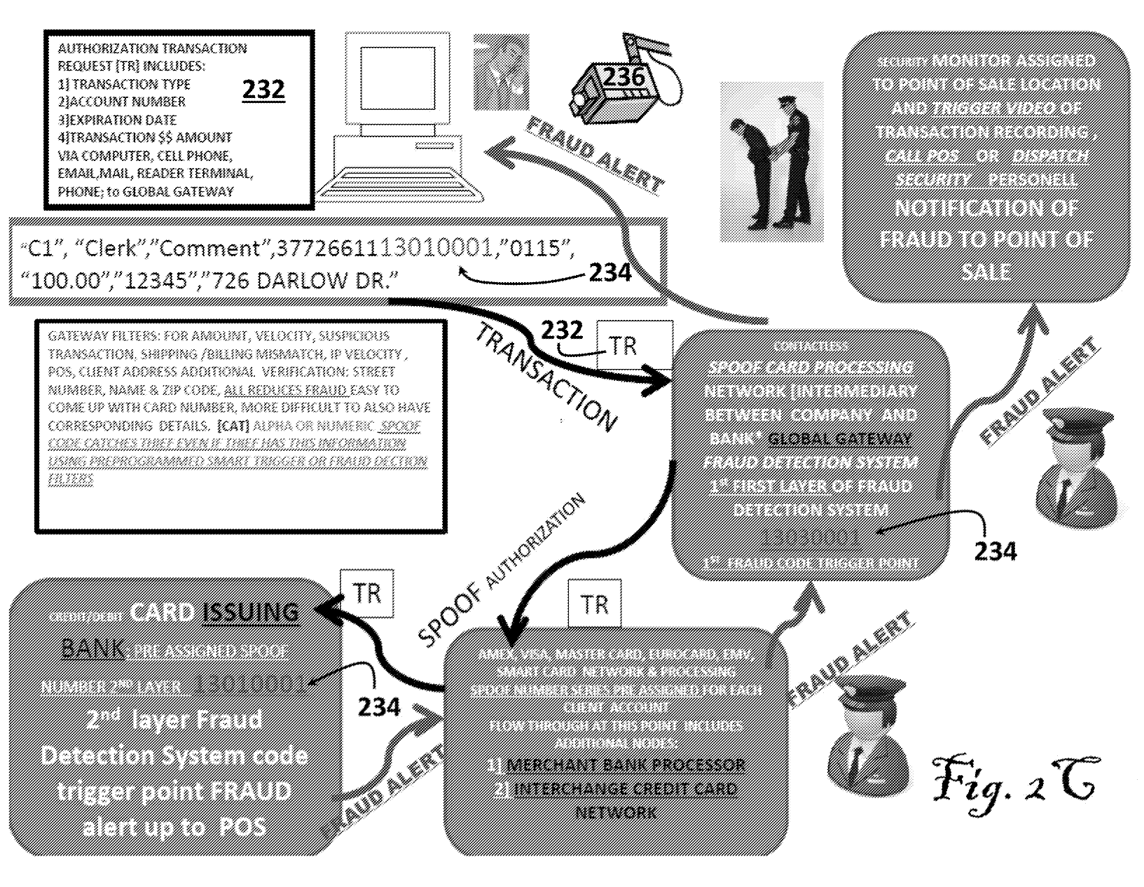

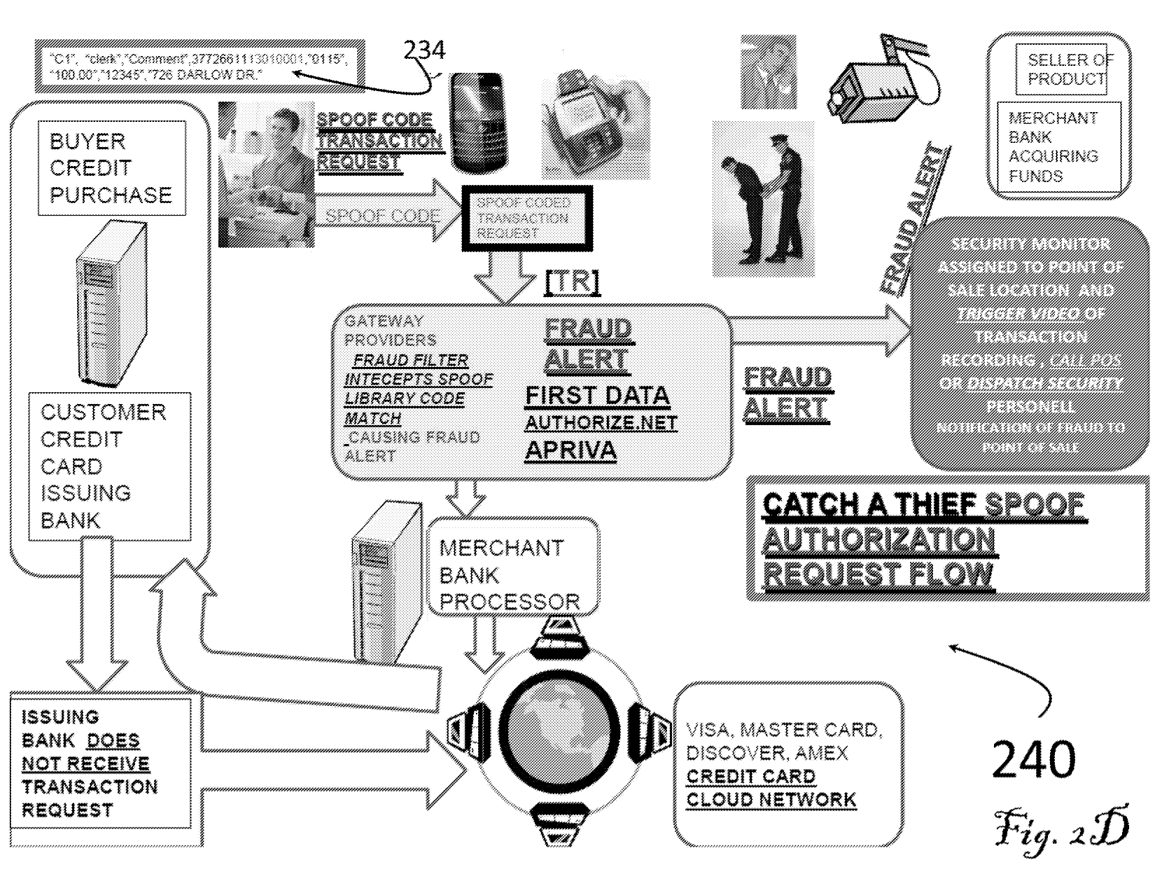

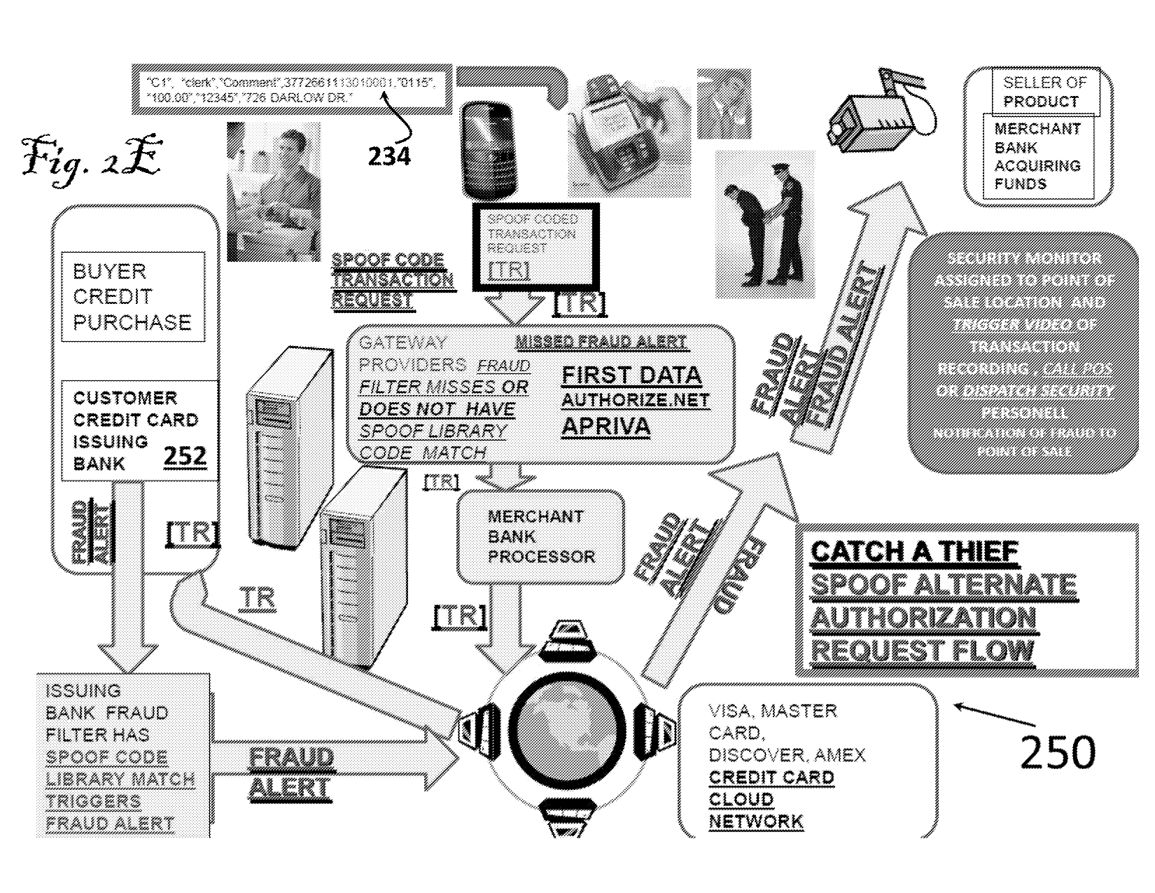

Embodiments of protective methods and devices of the current invention for protection against certain unauthorized extractions and criminal misuse of information stored on unprotected RFIDs are schematically illustrated in FIGS. 2A-2B. In an embodiment in FIG. 2A using “spoofing defense”, a misappropriation of the spoof code protected information may result from normal uses of a corrupted reading device 210 while the alert signal can be generated in an authorization process 211 performed during an attempted misuse of the stolen information. In the embodiment in FIG. 2B the misappropriation of the spoof number protected information may result from an active attempt to remotely read the information, for example using a briefcase reader 110. Again, an alert signal may be generated, in authorization process 211 performed during an attempted misuse of the stolen information 212 (“SPOOF ID CARD NUMBER SIGNAL FOR AUTHORIZATION” in FIG. 2B).

In FIGS. 2A-B a feature of the RF spoofing device of the current invention can include a credit/debit/smart card number or EPC code and/or name in a fraud library placed at the merchant gateway provider's network or credit card issuing bank in the Transaction Request [TR] 232 telephonic financial approval cycle. in a particular embodiment illustrated in FIG. 2C, the at least one characteristic spoof signature (potentially in encrypted or coded forms) 234 in the library may be readily accessible automatically in real time by at least one identifying processor for example operating a smart software filter arranged to identify and flag suspected attempts of fraud. This Smart Filter flag from a Spoof library can then be used to trigger a video or photo imager 236, call the point of sale clerk, or notify security or law enforcement nearby. The above operation may be managed and maintained, for example by a provider including, but not limited to, card issuing institutions, network providers, participating merchants, merchant financial institutions, low enforcement institutions, data security organisations and agencies, specialist and professional associations, and consortia of listed providers.

In the embodiment illustrated in FIG. 2D the “Gateway Provider” network 240 is illustrated intercepting the spoof code. And, the embodiment of a system 250, schematically illustrated In FIG. 2E, utilizes a spoof code in the form of preassigned codes or signatures 234 as provided by a credit/debit RFID card issuing bank 252. Either the merchant “Gateway Provider” or the card issuing bank 252 can trigger a fraud alert at the merchant POS, law enforcement, a consumer's mobile phone, fraud cloud network or area security.

A different class of embodiment of the methods and devices in accordance with the present invention may be based on prevention of acquisition of electronic proprietary information and/or data from unauthorized reading. One such embodiment entitled “STOP A THIEF” [SAT] is descriptively illustrated in FIG. 3A. For example, SAT may include LAYER #1 300 used as an outside layer currency-like paper or fine lossless dielectric paper with imprintable surface. As illustrated in FIG. 3A, one currency size (e.g. 6.250″×2.65″) 301 and two Smart Card size (e.g. 3.375″×X2.25″) 302 or business card size (e.g. 2.00″×2.50″), not shown in FIG. 3A, wallet protectors may include microgroove perforations 303 for clean product separation. LAYER #2 SAT may be an electrostatic fields, RF, and/or EMF blocking layer 305 incorporating, but not limited to, aluminum foil, copper foil, nickel alloy cloth, Nickel Cobalt alloy cloth or sheet stock approximately 0.00.1″ to 0.01″ thick, and having similar outline dimensions as the LAYER #1 300. LAYER #3 SAT may be similar to the LAYER #1 in form, fit, and function. It may include an imprintable protective layer of paper or static free plastic, aluminum or copper foil, laminate of polyester, polyethylene, and/or customized metal paper. Also, it may incorporate a preferable surface for promotional advertising (e.g. including, but not limited to, QR code 306 end/or bar code 307 often used with mobile web sites on smart phones and/or NFC enabled mobile phones).

One may note that the current invention is not limited to the illustrated sizes and may include layers of bank check size, various not buck sizes, or any other appropriate size arranged for convenient insertion into wallets, clothing, name tags, luggage, clothing, and even bandages for person, animal, and livestock privacy and/or proprietary data protection.

Yet another embodiment of the present invention entitled “CATCH A THIEF” CAT is schematically illustrated in FIG. 3B. An exemplary CAT may include two layers in, either, currency, Smart Card, and/or business card size configurations. A CAT may also incorporate a PASSIVE RFID chip [no internal power required to operate, external energy from a reader or NFC enabled cell phone reads the EPC or UPC or personal encoded data.] LAYER #1 may use an outside layer “currency like” paper or fine lossless dielectric paper with imprintable surface for promotional or important information. LAYER #2 may incorporate coded RFID chip 310 [or in different versions chips] with integrated passive antennas 312 such as meander line, squiggle, spirals, end fire, flat plate or potentially with matching parasitic or “Rectenna” elements. Chips 310 may be programmable to provide spoofing signals programmable and incorporating encrypted spoofing ID number ciphers, codes representing information readily identified by law enforcement, bank card security, merchant gateway providers to provide actionable intelligence for the capture of criminals at the point of sale or to record photographic or video information as evidence for prosecution of a thief. It may also be used to track and locate Internet Protocol [IP] addresses and/or geolocation of computers used by the thief.

In addition, as illustrated in FIG. 3B, the protective device incorporates the dielectric LAYER #1 which may incorporate at least one optional clear dielectric window 309 allowing potential users to view and visually inspect the LAYER. #2 portions such are RFID chip 310 or the antennas 312.

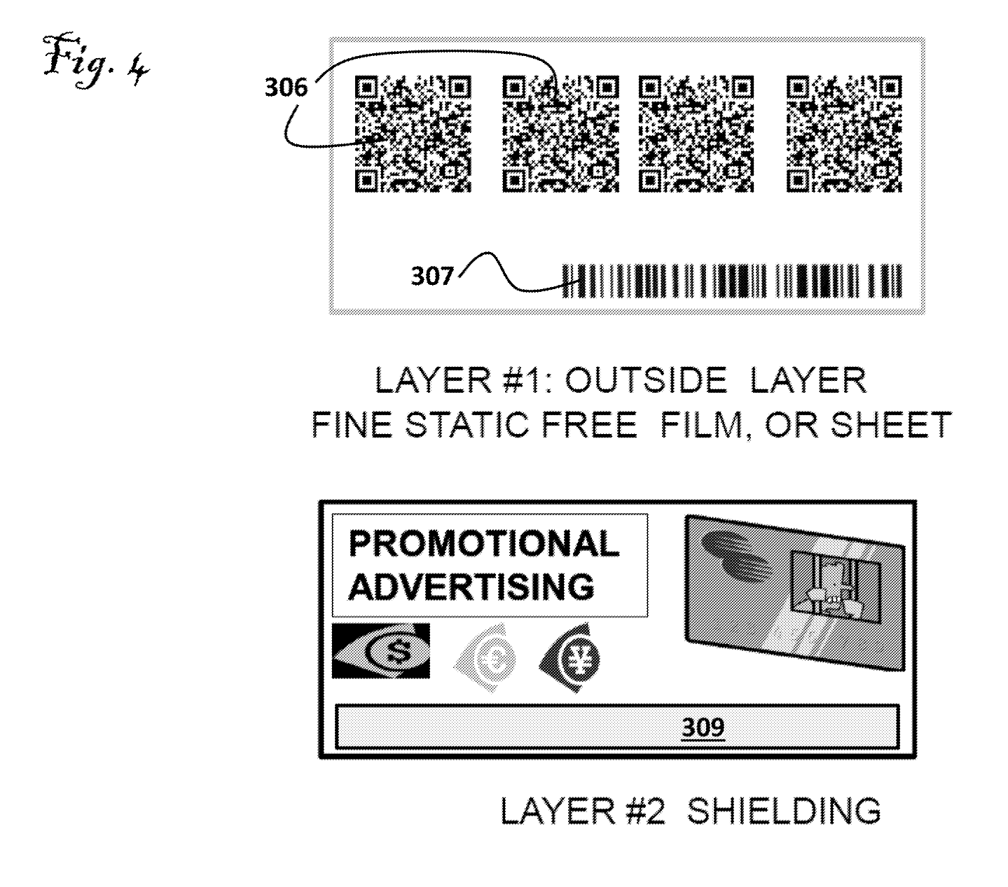

Furthermore, in an embodiment related to one illustrated in FIG. 4, the outside LAYER #1 may incorporate multiple codes 306 and 307, while the LAYER #2 may incorporate at least one clear dielectric window 309 enabling optical inspection and/or optical scanning.

Yet another embodiment illustrated in FIG. 5, may incorporate at least one layer 510 arranged tor electrostatic protection by incorporation of materials having surfaces substantially free of electrostatic charge accumulations, also, at least one additional layer 520 may be arranged for enhanced surface electrical conductivity (e.g. a film of Silver and/or Copper). Both layers may be additionally used to support printed information, such are (but not limited to) useful phone numbers, e-mail addresses, electronic contact info, advertisements, trademarks, logos, affiliation symbols, slogans, proverbs, motivational messages, and combinations of the above.

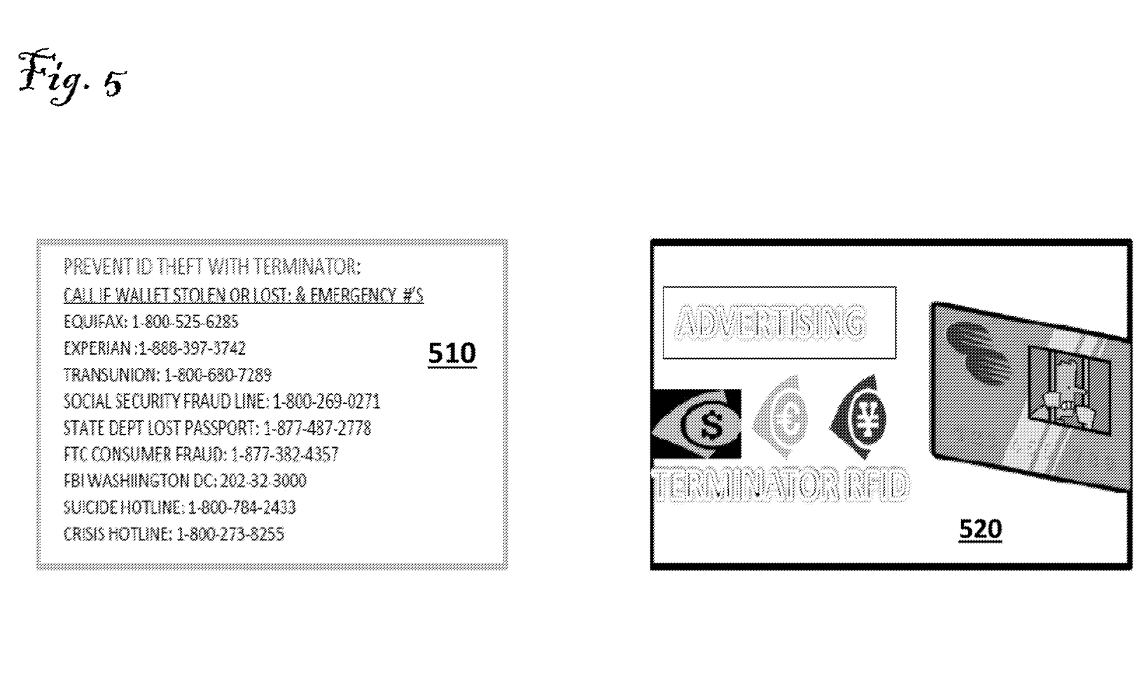

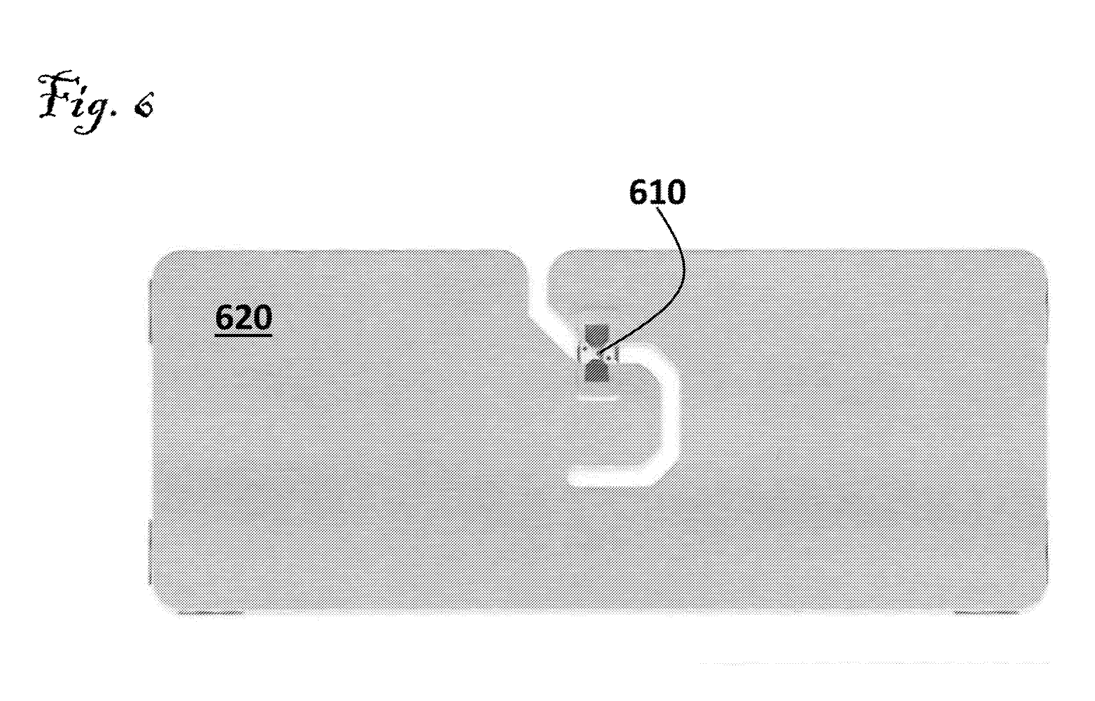

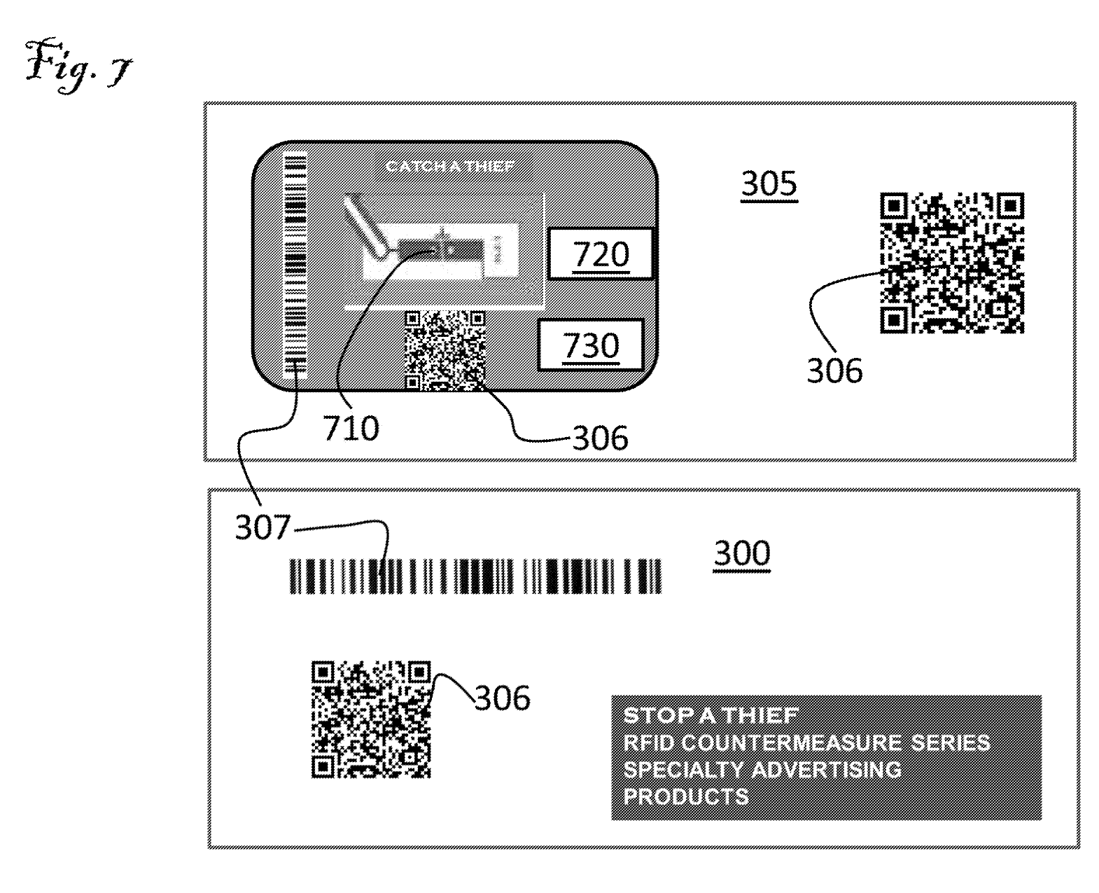

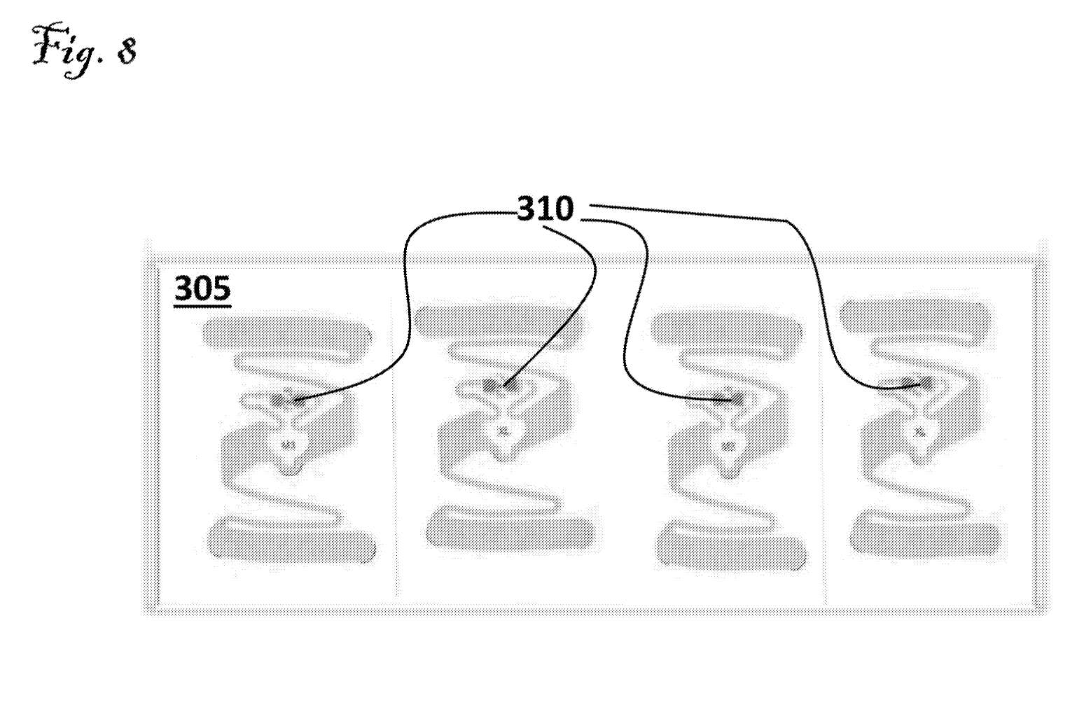

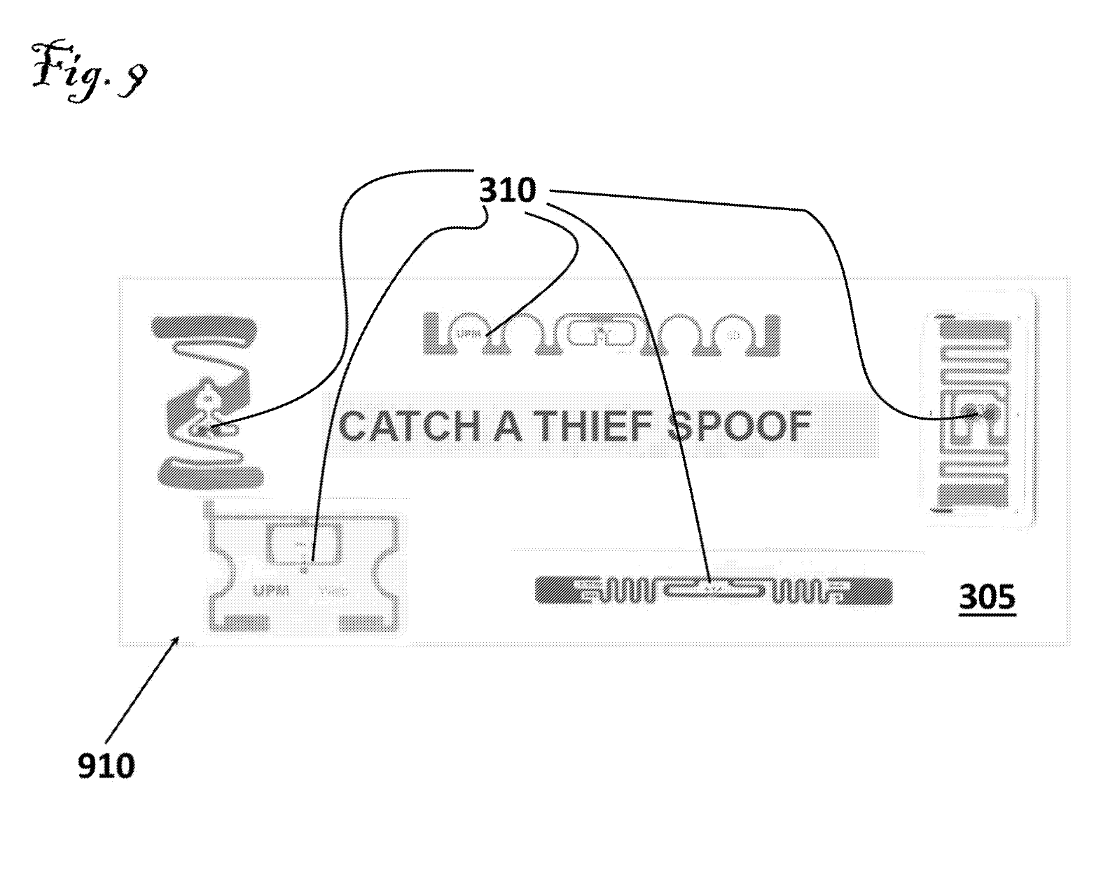

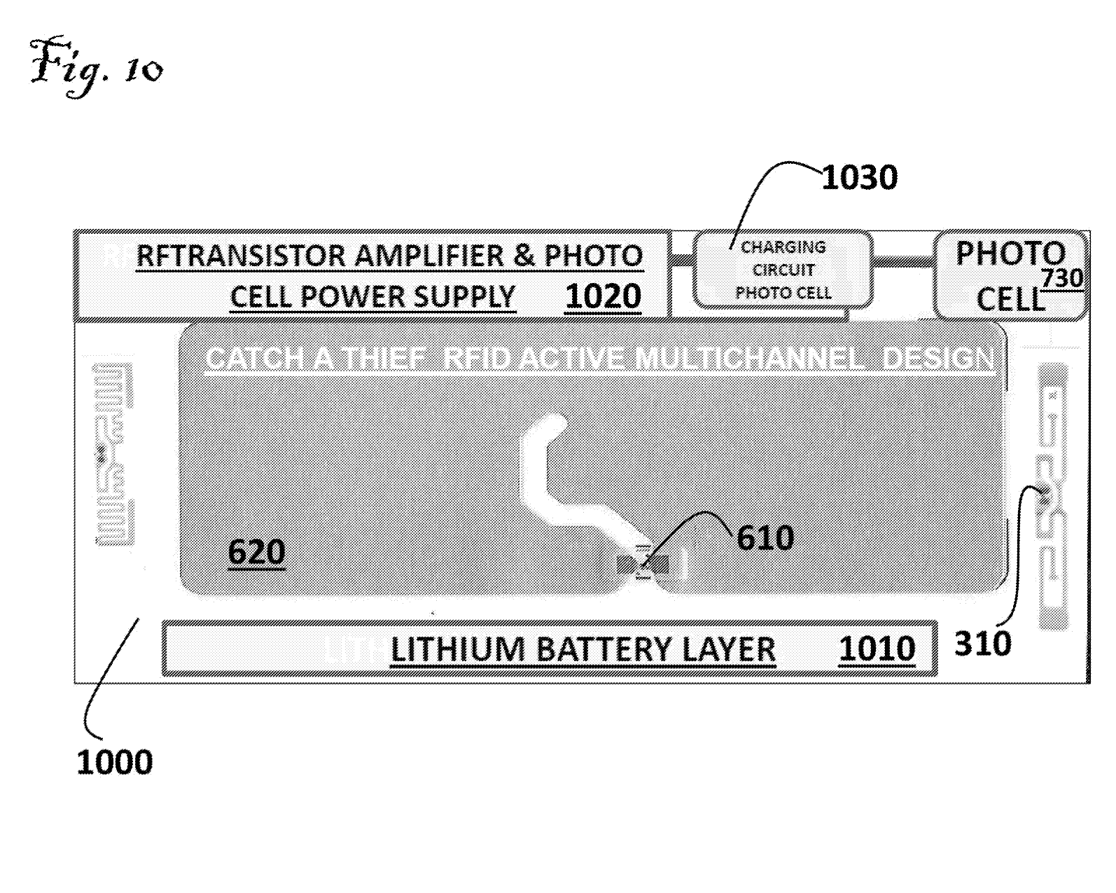

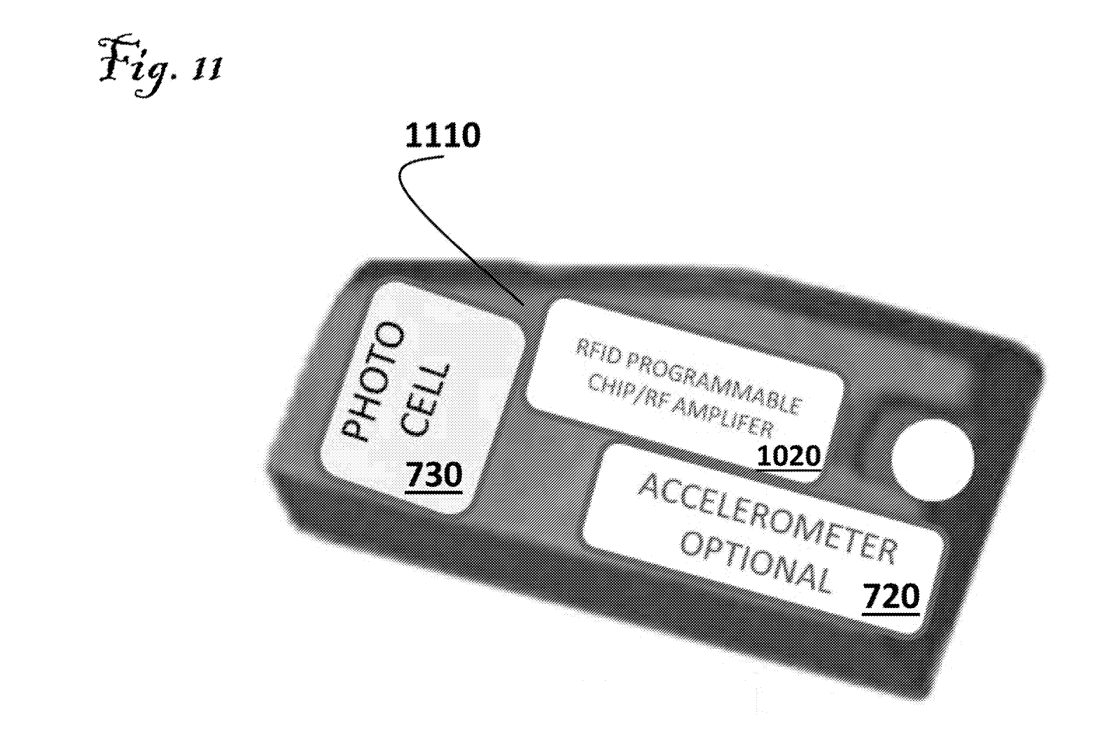

Shown in FIG. 6 is an illustration of a flat plane embodiment using at least one ground plane like antenna 620. In the FIG. 6—illustrated flat plate design, the ground plane like antenna, may be arranged to function as an element arranged to absorb and/or emit electromagnetic radiation while simultaneously acting as a shield arranged to prevent propagation of undesirable electromagnetic fields. Thus, it may be useful both as a conductive layer 520 arranged as a shield and in analogy to the antenna 312 (FIG. 38) for the particular RFID chip structure 610. In different embodiments, the RFID chip structure 610 may foe arranged to emit, upon undesired interrogation attempt of unauthorized readout of information, a aforementioned “spoof signal” or radiation intended to prevent further unauthorized or undesired actions.

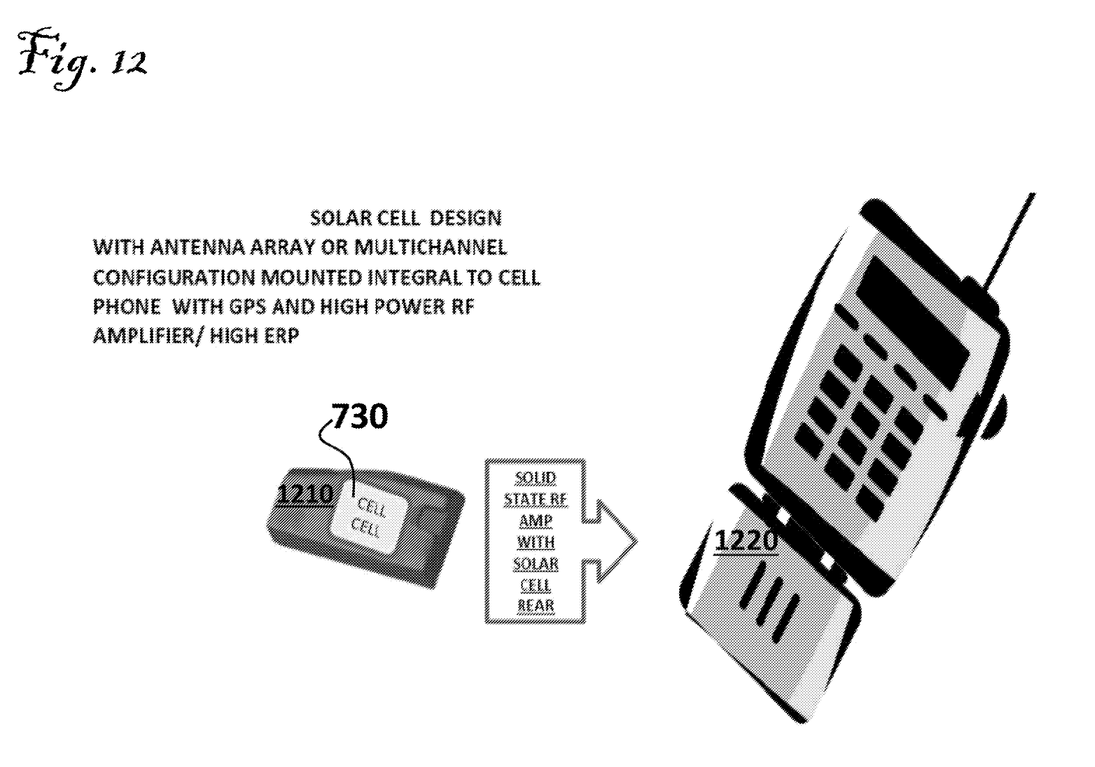

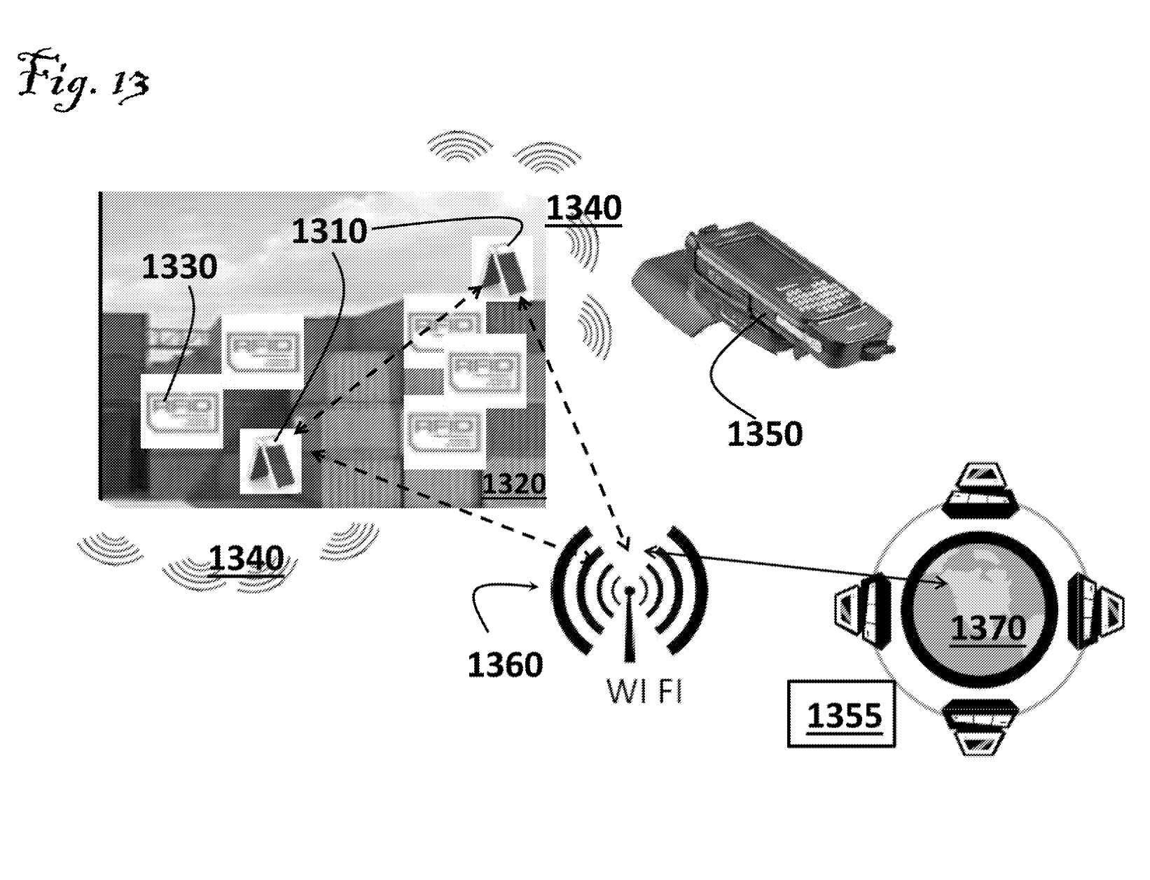

Further embodiments are illustrated in FIG. 7. The outside LAYER #1 300 may incorporate multiple codes 306 and 307, while the LAYER #2 305 may incorporate coded RFID chip 310. These layers may be used together in close proximity or separately, separated, for example by media containing information of importance to be protected. When activated, the RFID chip 310 spoofing signal may provide a plurality of spoofing signal for different EPC or UPC codes or pseudorandom Manchester codes and/or alphanumeric profiles. In the case of hostile intent the RFID chip 310 can be programmed with Remotely Accessible Trojans [RATs] or counter offensive polymorphism malware with automatic generation of code variants to defeat signature recognition by antivirus programs. And with these variants it is possible to inject defensive malware/botware into hostile or fraud related electronic devices. Such passive or passive/active layers may be flexibly programmed as well.

In some versions of the embodiment illustrated in FIG. 7, In LAYER #2 305 an ACTIVE RFID transmit & receive [transceiver] element 710 may foe added, incorporating, for example an RF amplifier powered by a multilayer Gallium Arsenide, Indium Gallium Arsenide, Mercury Cadmium Telluride and/or Germanium photocell 730. An attendant charging circuit may provide power to a layered Lithium battery. These may be interfaced with an accelerometer 730 for providing motion sensing queuing, coding or discrimination if desired. The accelerometer 730 may interface with an ACTIVE RFID element 710 microcontroller (for example, at about 8 MHz, consuming about 225 μA at 3V, at an exemplary sampling rates of about 0.75 MHz) . Different accelerometers may utilize up to 750 μA of current, potentially needing additional complexities such as batteries and charging circuitry.

In particular embodiments, an accelerometer 720 may initiate, for example, a Gauss Espionage Trojan [GET] which may utilize basic encryption of the spoofing attack payload via plethora of hash iterations on attributes of a mobile phone or attacker host computer system. This spoof malware may, thereby, be surreptitiously introduced info a hostile attacker or eavesdroppers' cyber processing system on a computer or in a cloud.

FIG. 8 illustrates a class of embodiments utilizing a plurality of RFID chips 310 associated with the layer 305. It may be noted that the RFID chips of different embodiments may be placed differently and associated with different structures in proximity to the sensitive/personalized information. In such embodiments, the plurality of RFID chips may foe arranged to emit a plurality of different signals (e.g. associated with a plurality of channels) or some of the RFID chips 310 may emit substantially similar signals arranged for mutual support (e.g. augmentation of amplitude and/or extent of coverage of the protected volume relative to such pertinent to a single RFID chip).

Similarly, FIG. 9 illustrates utilizing an array 910 of different RFID chips 310 associated with the layer 305, The array 910 may be arranged to operate as a unit emitting substantially identical spoofing message (e.g. related numerical spoofing codes) or may be arranged such that individual Chips 310 may emit individualized information simultaneously or in sequence, for example in order to provide broader protection over several channels or domains potentially utilised for unauthorised interrogation. In other embodiments, the RFID chips 310 may be arranged to respond adaptively to the particular interrogation events emitting appropriate coded information (e.g. emitting simultaneously superimposed signals followed by specific information pertinent to predetermined channel or frequency domain). In addition, in an approximate analogy with the exemplary embodiments illustrated in FIG. 6, the blocking layer 305 (or on the side opposite to the layer 305) my incorporate at least one antenna structure similar to the antenna structure 620.

Also, in the case of hostile intent or electronic eavesdropping on privacy or privileged information on Smart ID card microprocessor chips may be abed and programmed to control functions of separate Chips 310. As recited above, this class of embodiments may also use Remotely Accessible Trojans [RATs] and/or counter offensive polymorphism malware with automatic generation of code variants to defeat signature recognition by antivirus programs. Furthermore, with these variants it may be possible to inject malware; botware into hostile or fraud related electronic eavesdropping. Thereby, defensively using a Flashback Trojan [FT] with basic encryption to bind to downloaded module in an attackers computer or Over The Air [OTA] processing network. In particular, in exemplary embodiments pertinent to the illustrations in FIG. 7, incorporating an accelerometer 720 initiating a Gauss Espionage Trojan which may use basic encryption of the spoofing attack payload via thousands of hash iterations on attributes of a mobile phone or attacker host computer system. This spoof malware can thereby be surreptitiously introduced into a hostile attacker or eavesdroppers' cyber processing system on a computer or in a cloud.

In alternative embodiments an absorptive layer with matching slow wave ability a conductive ground plane or carbon nanotube film with embedded or etched parasitic reflective antenna elements on an anti static plastic or conductive sheet may be employed. Also, signals blocking combinations of additional layers (e.g. LAYER #3 & LAYER #4 may be used separately or layered with different embodiments of layers such are LAYERS #1 and #2.

Additionally, layer (or layers) corresponding to the additional layers may include electromagnetic layered flexible cloth or paper sheet embedded with a carbon base composite slow wave structured or RF absorptive coating. Even further, additional layers (e.g. corresponding to the LAYER #4) may include embedded reflective dielectric elements and may incorporate anti-static materials compounds, carbon nanotube films or layers, and/or combinations of the above materials.

In a particular embodiment, LAYER #3 may incorporate (but not limited to): an outside layer fine static free film, or sheet (e.g. 2.61 inches high×6.14 inches wide×0.0043 inches thick). In a different exemplary embodiment an inner sandwich layer may incorporate magnetic shield and electric field attenuative laminated, iron on, or adhesive-bonded as or, if required, absorptive layer of shielding and conductive film or fabric such are, but not limited to, polyester Nickel-Copper-Nickel-Ni cobalt alloy cloth, Aluminum or Copper foil, or sheet composite or carbon composite (CobalTex™, VeilShield™, RADIOSCREEN™, ARGENMESH™, STATICOT™, and/or similar commercially available materials and it's combinations.)

For example, 0.004″ to 0.058″ thick matching layer 1 outline or smart card 2.0″×3.25″ dimensions this layer may be imprintable stock and or Electro and Magnetic Field [EMF] absorptive and/or reflective (including high power Electromagnetic Pulses EMP), while the LAYER 14 (approximately 0.004″ to 0.058″) may be an imprintable protective layer of static free plastic on pure copper polyester taffeta, or imprintable laminated copper or aluminum sheet or foil laminated with imprintable polyester, polyethylene or customized metal paper. Such a layer also may contain any imprinting or advertising for a customer or instructional material useful to contact fraud protection organizations and emergency contact information. Such a layer may also be used for printing other instructive information on product use. In addition, LAYER #4, depending on particularities of different embodiments, could be a conductive thin or thick film suitable for printing multi color custom art or any information or instructions.

While the above embodiments (e.g. FIGS. 3-8) may represent a group of countermeasures “without signal amplification” (also indicated here as the “passive only” as it may use energy radiated by the interrogation transmitters) an additional group of embodiments of the current invention includes cases where enhancing the spoofing countermeasure signal to noise ratio [s/n] is required. Depending on the power level requirement, an internal or external energy storage module may be utilised potentially based on chemical, thermal, photonic, mechanical, or radioactive energy sources. In particular, some autonomous (“of the netted RFID grids or networks”) military or civilian embodiments may feature ability to use integrated or independent power source (e.g. a photosensitive cell and arrays including solar photocells and arrays) as a requirement. Depending on the power level requirement, an internal or external energy storage module may be utilized potentially based on chemical, thermal, photonic, mechanical, or radioactive energy sources.

In particular, some autonomous (“of the netted RFID grids or networks”) military or civilian embodiments may feature, as shown for example in FIGS. 10-12, ability to use an integrated or independent solar power source. In addition or alternatively (e.g. in the case of RECTENNA's) the RF energy induces AC energy then converted to DC to provide essentially passive chips and microprocessors with an active RF power transmitter amplifier capability for longer RFID detection ranges or longer transmit lives.

A class of embodiments utilizing local power elements and RF amplification is schematically illustrated in FIG. 10. The protective “CATC A THIEF” device 1000 may further incorporate at least one electrochemical source of electrical power 1010 (such as “LITHIUM BATTERY LAYER” in FIG. 10 and/or photo cell 730) and at least one RF amplifier 1020. It may be noted that the photo cell 730 charging circuitry 1030 maybe realized as a separate module or integrated in the RF amplifier assembly 1020.

A different active embodiment is illustrated in the schematic in FIG. 11. The device illustrated in FIG. 11 may lend itself better to a key fob 1110 in terms of increased spoofing signal coverage and signal strength for digital signature transponder (DST) or similar non-contact card or contactless key security applications. An embodiment-specific RFID programmable Chip/RF amplifier may be included and arranged to function in synergy with customary automotive tusks (e.g. doors locking/unlocking, location and emergency signaling, emergency shutdown of desired subsystems, etc.) In specific embodiments the RFID chip/RF amplifier, may be arranged to emit predetermined spoofing code after being triggered by detection of an unauthorized attempt of reading of protected/privileged electronic information anywhere of a predetermined volume. In different embodiments, the spoofing defensive may be owner/user activated being switched on, for example, by forcing predetermined patterns and sequences of acceleration of the key fob 1110 as detected by the at least one accelerometer 720. It may be noted that related embodiments my also utilize the photocell 730 arranged to provide power at least to a portion of associated electronic components.

In another related embodiment the protection device may foe packaged in a 25 mm×12 mmx×10 mm wedge replicating known 12.0 mm×6.0 mm×3.0 mm wedge DST unit. Such fob wedge device [or similarly sized and configured device hung or adhesively fixed to a convenient precipitous location] may spoof the DST RFID hacker using an active group of frequency codes that may be factory installed or programmed off site. The active high level RFID signal may use a series of spoof encryption keys. These keys may use as defensive endless loop ciphers, faux ignition kill codes, and/or software viruses of worms to infect the fraudulent interrogation device. The software worm could be used defensively to damage the abusers interrogation tool or use a cipher that would squawk to another device monitoring the web at one of the world wide RSA encryption fraud monitoring centers. The defensive worms may only be activate when the interrogation device transmitted information, for example, via WIFI or internet connection below the level of awareness of the abuser, thereby providing and ID and GPS geolocation of the malevolent activity and fraudulent computer ID source.

Conceptually similar defensive devices of different embodiments may be associated with other portable electronic devices and prearranged to defend relatively extensive regions against the unauthorised data acquisition attempts. One such device 1210, associated with a cellular phone 1220, is schematically illustrated in FIG. 12. In the illustrated embodiment the device 1210 may incorporate subsystems for detection of unauthorized information readout and emission of protective spoofing codes or a preprogramend jamming signals, as disclosed above in connection with the discussed embodiments. In different embodiments, a different device 1210 may be arranged to utilize functional elements and/or subsystems of the associated cell phone 1220, including but not limited to, power supplies and energy storage, amplification modules, radiation modules, memory modules, processors, GPS modules, antennas and/or combinations of the above. As above, one may note that the additional complexity and functionality of the defensive systems operating in synergy with additional electronic systems may yield to extended area coverage and/or utilization of more sophisticated methods and algorithms for treats detection and resulting counter-measures.

In a class of embodiments directed toward protection of information contained in a protected volume (e.g. stores, storage areas, storage terminals, airports, port facilities and similar) a plurality of interconnected active protective devices 1310 may be employed. In the illustrated embodiment, sensitive information on a protected cargo 1320 may be encoded on electronic media 1330 (e.g. RFID chips). This information may be protected by the active protective electronic devices 1310 either by continuous emission of a protective signal 1340 (spoofing and/or jamming), or may defensively react (either locally or by activation of portions of entire network) to attempt of unauthorised interrogation (e.g. by a portable hostile RFID reader 1350) by emission of the protective response signal 1340 as needed.

In some embodiments, the protective electronic devices may be controlled and information managed using an integrated management system 1355 operating remotely or globally and arranged to process information pertinent to the protected privileged information, attempts of unauthorized acquisition of such information, defensive actions of the active protective devices, optimization of spoofing and/or jamming activities, and initiation and execution of defensive actions and procedures intended to interrupt, prevent, or discourage current and future attempts of acquiring, distribution, and abusing the privileged information.

One may note that the entire protective system may foe integrated using a local WIFI network 1360, further connected, for example via the web 1370, with at least one enabling substantially global defensive strategies and capabilities of global defensive responses.

It may be of interest to also protect middleware and

cloud computers from viruses and worms. Virus infected tags can attack middleware and cause inventory control chaos. Internet and smart phones amplify risk of cyber attack, cost effective countermeasures are important to ensure the integrity of the readers, middleware and cloud authentication and fraud processing centers that exist for worldwide protection from major fraud. Malevolent software (malware) including worms and viruses may be of significant concern of homeland security where the malware has the potential of crashing and confusing industrial control systems [power plants, transportation, manufacturing lines] as well as warehouse and worldwide logistics operations [airport baggage, FedEx and ups] and emergency networks. There may be a need today to have industry incorporate countermeasure techniques in to RFID system applications. Worms and viruses may be designed to seriously effect and infect the current RFID system, population.

Many RFID tags may have limited amounts of storage; usually less than 1024bits. These may be regarded as small computers becoming federated worldwide as subsets to process control, transportation, retail, medical, manufacturing, and banking, credit, smart card and logistics networks. Threats may be countered using anti-hacker spoofing codes as pre initialized defensive viruses (or “antibodies” in an immunological analogy) or worms in an RFID tag. Recognition codes in middleware can recognize these signals giving a heads up to the system manager there is a hacker at work. Currently middleware is vulnerable to structured query language [SQL] attacks or bogus fags that can cause buffer overflows. Worms designed to self replicated and abuse the network and the cloud are practicable through overwhelming the system with data replicating copies of an RFID worm code. In addition a virus self replicating code that corrupts the RFID tags without requiring ad network be involve is also practicable. With a virus newly infected tags may infect the backend of the system and or shell to disrupt it.

Some of current data bases potentially vulnerable to infections may include (but not limited to): MY SQL [MY SQO-C-API], Oracle [OCI 10.2.0]; [SQL*PLUS], Postgresql [LIBPQAPI], SQL server [SQL distributed management objects].

Exploits may include:

a] Databases: simple SQL injection
b] Web based: client-side scription to exploit WMF bug

SSI exec commands

c] middleware: Glue code:

1] C and C^{*} programmed memory may be vulnerable to buffer overflow.

2] Executing maleware shell commands

3] Buffer overflow, and others.

4] Randomly Accessible Trojan Horses [RAT's] and other malware including for example; [keylogger, screen capture, SHELL(command),password capture).

5] Malware targeted to compromise networks and access ID credentials.

Viruses, malvare, and worms may be written by hackers, cyber warfare organizations, sabotage, and terror attacks by using quines [that print their own source code] in conjunction with SQL commands using single and multiple quines. SQL virus can use quines for mysql and SQL injection may destroy part of a database by exploiting select query and executing shell commands. In addition polymorphic and metamorphic code variants with Trojans attached to freeware and AFP's are flooding the Banking and Financial cyber security platforms via SMS, downloading and human interface using thumbdrives. All in pursuit of Financial Fraud and Denial of Service attacks to disrupt commerce. In today's cyber world an attack on infrastructure and commerce is being examined as an act of war under international law.

Payloads may include:

destroy data using SQL injection,
denial of service using SQL injection,
reading data from the database,
execution shell commands using SQL injections,
client side scripting,

server side includes,

backdoors using shell commands,

executing code using shell commands,

binary code injections,

distributed denial of service [Ddos] saturation “zero day” attacks.

Other embodiments of the current invention may include devices and methods arranged to spoof HF, UHF or Microwave or multispectral RFID devices the same technology may be used to spoof optical devices: LED's or LCD's IR-LEDs, or lasers optical ID [OPID] devices; [there are developments in optical RFID at 333thz [900 nm], 380 THz [750 THz (400 nm) where layers 3 & 4 of the invention, would be effective]. In addition there are RFID antenna replacement alternatives using photovoltaic components and IR-LEDs or even LASER technology.

While specific values, relationships, materials and components have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the embodiments and certain modifications of the concepts underlying the present invention, various other embodiments as well as certain variations and modifications of the embodiments herein shown and described will obviously occur to those skilled in the art upon becoming familiar with such underlying concepts. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

We claim:

1. A protective method for prevention of unauthorised acquisition and unauthorized use of privileged information comprising:
a) generating at least one characteristic spoof signature and associating the at least one spoof signature with the privileged information such that the at least one spoof signature is acquired during the unauthorized acquisition of the privileged information;
b) establishing at least one identifying processor arranged to identify the at least one spoof signature, to classify at least one attempt of unauthorized use of the privileged information and to generate at least one authorization for at least one predetermined set of actions organized to prevent the unauthorized use of the privileged information;
c) communicating the at least one authorization to a party proximal to the at least one unauthorized use of the privileged information in time sufficient for interruption of the at least one unauthorised use of the privileged information.

2. The method of claim 1, wherein, the at least one privileged information includes electronically identifiable information which has been incorporated in and supported by a medium chosen from a set of media consisting of: identification cards and passes, personal identification documents and chips, credit and debit cards, department store cards, restricted access cards and chips, electronic keys, electronic passes and tickets, boarding cards and passes, luggage and parcel identification labels and chips, public transportation tickets and passes, parking tickets and passes, laundry labels and smart cards, electronically-enabled receipts, electronic toil passes, electronically-encoded objects and documents, and combinations of the listed media.

3. The method of claim 1, wherein the at least one characteristic spoof signature have been supported by at least one RFID enabled device arranged to emit at least one spoofing signal containing the at least one characteristic spoof signature.

4. The method of claim 3, wherein the at least one characteristic spoof signature have been organized as a coded portion integrated in data on at least one RFID enabled device arranged to emit at least one spoofing signal.

5. The method of claim 3, wherein the at least one spoofing signal containing the at least one characteristic spoof signature emitted by the at least one RFID enabled device when interrogated by at least one corrupted reading device.

6. The method of claim 4, wherein at the least one corrupted reading device has been chosen from a set of corrupted reading devices comprising corrupted parasitic RFID readers, disguised mobile RFID readers, and interceptor readers.

7. The method of claim 1, wherein the at least one identifying processor have been organized and managed by at least one provider chosen from a group of providers consisting of: card issuing institution, network providers, participating merchants, merchant financial institutions, low enforcement institutions, data security organizations and agencies, specialist and professional associations, and consortia of listed providers.

8. The method of claim 3, wherein card issuing institution, network providers, participating merchants, merchant financial institutions, low enforcement institutions, data security organizations and agencies, specialist and professional associations, and consortia of listed providers.

9. The method of claim 3, wherein, the at least one RFID enabled device includes at least one RFID chip and at least one antenna structure chosen from a set of antenna structures consisting of distributed antennas, mutually correlated antennas, loop antennas, rod antennas, disc-cone antennas, end fire antenna arrays, E-Plane notch antennas, meander line antennas, spiral antennas, printed log periodic antennas, dish antennas, slot arrays, surface-mounted antennas and arrays, dipole and multipole antennas, antennas with reflectors, antennas with directors, antennas with horns, antennas with waveguides, antennas with strip lines, laser antennas, and antennas with fluid components.

10. The method of claim 3, wherein the at least one RFID enabled device includes at least one layer having enhanced electrical conductivity and a slot arranged to emit at least one spoofing signal containing the at least one characteristic spoof signature while precluding propagation external electromagnetic fields through the at least one layer having enhanced electrical conductivity.

11. The method of claim 3, wherein the at least one RFID enabled device incorporates at least one imprintable protective layer including at least one imprint chosen from a set of imprints consisting advertising message, advertising alphanumeric imprint, advertising graphical imprint, advertizing marks and symbols, OR coded imprints, bar-coded imprint, imprint including useful information, and combinations of listed imprints.

12. The method of claim 3, wherein the at least one RFID enabled device includes at least one electrical energy storage system and at least one additional electronic subsystem chosen from a set of electronic subsystem consisting integrated or independent power sources, electrochemical battery, photosensitive power cells and arrays, multilayer Gallium Arsenide photocell, Indium Gallium Arsenide photocell, Mercury Cadmium Telluride photocell, Germanium photocell, electronic amplifiers, RF amplifiers, accelerometers and combination of listed electronic subsystems.

13. A protective method for prevention of unauthorized acquisition and unauthorized use of privileged information located in a predetermined protected volume comprising:
a) providing at least one protective electronic device associated with the protected volume and arranged to receive at least one unauthorised interrogating electronic signal and generate and emit at least one protective response signal;
b) prearranging at least one characteristic spoof signature and associating the at least one spoof signature with the at least one protective electronic device privileged information such that the at least one spoof signature is acquired the during the acquisition of the at least one protective response signal;
c) establishing at least one integrated management system connected with the at least one protective electronic device and arranged to: receive and process information pertinent to the protected privileged information and attempts of unauthorized acquisition of the protected privileged information, determine and control defensive actions of the active protective devices, and initiate execution of defensive procedures intended to interrupt, prevent, or discourage current and future attempts of acquiring, distribution, and abusing the privileged information,

14. The protective method of claim 13, wherein at least one protective response signal have been arranged to prevent acquisition of the privileged information located in a predetermined protected volume while substituting the privileged information by the at least one spoof signature.

15. A protective device for prevention of unauthorized acquisition and unauthorized use of privileged information comprising at least one RFID enabled device arranged to emit at least one spoofing signal containing at least one characteristic spoof signature;
wherein the at least one RFID enabled device includes at least one RFID chip and at least one antenna structure chosen from a set of antenna structures consisting of distributed antennas, mutually correlated antennas, loop antennas, rod antennas, disc-cone antennas, end fire antenna arrays, E-Plane notch antennas, meander line antennas, spiral antennas, printed log periodic antennas, dish antennas, slot arrays, surface-mounted antennas and arrays, dipole and multipole antennas, antennas with reflectors, antennas with directors, antennas with horns, antennas with waveguides, antennas with strip lines, laser antennas, and antennas with fluid components.

16. The protective device of claim 15, wherein the at least one RFID enabled device includes at least one layer having enhanced electrical conductivity and a slot arranged to emit at least one spoofing signal containing the at least one characteristic spoof signature while precluding propagation external electromagnetic fields through the at least one layer having enhanced electrical conductivity.

17. The protective device of claim 15, wherein the at least one RFID enabled device incorporates at least one imprintable protective layer including at least one imprint chosen from a set of imprints consisting advertising message, advertizing alphanumeric imprint, advertising graphical imprint, advertizing marks and symbols, QR coded imprints, bar-coded imprint, imprint including useful information, and combinations of listed imprints.

18. The protective device of claim 15, wherein the at least one RFID enabled device includes at least one electrical energy storage system and at least one additional electronic subsystem chosen from a set of electronic subsystem consisting integrated or independent power sources, electrochemical battery, photosensitive power cells and arrays, multilayer Gallium Arsenide photocell, Indium Gallium Arsenide photocell, Mercury Cadmium Telluride photocell, Germanium photocell, electronic amplifiers, RF amplifiers, accelerometers and combination of listed electronic subsystems.

19. The protective device of claim 15, wherein the at least one RFID enabled device includes a plurality of RFID chips.

20. The protective device of claim 19, wherein the plurality of RFID chips has been arranged to emit a plurality of substantially similar signals designed to augment protective coverage.

21. The protective device of claim 19, wherein the plurality of RFID chips has been arranged to emit a plurality of substantially distinct signals associated with a predetermined plurality of channels.

22. The protective device of claim 19, wherein the at least one RFID enabled device includes at least one RF amplifier, at least one charging circuit, and at least one photosensitive power element.

23. The protective device of claim 15, wherein the at least one RFID enabled device has been arranged in a key fob.

24. The protective device of claim 15, wherein, the at least one RFID enabled device has been associated with a mobile cell phone.

25. The protective device of claim 24, wherein the at least one RFID enabled device has been arranged to arranged to operate in synergy with the associated mobile ceil phone utilizing at least some functional elements and subsystems of the associated cell phone.
